(19) United States
(12) Patent Application Publication
(10) Pub. No.: US 2019/0226456 A1
(43) Pub. Date: Jul. 25, 2019

(54) System and Method for Evaluating Loads of a Potential Wind Farm Site for Multiple Wind Scenarios

(71) Applicant: General Electric Company, Schenectady, NY (US)

(72) Inventors: Mark Mitchell Korfein, Latham, NY (US); Daniel Leathem, Saratoga Springs, NY (US); Ching-Ling Huang, San Ramon, CA (US)

(21) Appl. No.: 15/875,018

(22) Filed: Jan. 19, 2018

(51) Int. Cl. F03D 17/00; G05B 15/02

(52) U.S. Cl. CPC F03D 17/00; G05B 15/02

(57) ABSTRACT

A system and method for evaluating loads of a potential wind farm site for multiple wind scenarios includes (a) receiving, via a computer server, site data of the potential wind farm site representing at least one wind scenario for at least one wind turbine at the potential wind farm site. Further, the method includes (b) selecting, via a user interface, a wind farm configuration based on the at least one wind scenario. The method also includes (c) selecting, via the user interface, a time period for the at least one wind scenario. Thus, the method includes (d) automatically generating, via the computer server, a mechanical loads analysis for the selected wind farm configuration and the time period.

### FIELD

The present invention relates generally to wind turbines, and more particularly, to systems and methods for evaluating loads of a potential wind farm site for multiple wind scenarios.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and a rotor. The rotor typically includes a rotatable hub having one or more rotor blades attached thereto. A pitch bearing is typically configured operably between the hub and a blade root of the rotor blade to allow for rotation about a pitch axis. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

A plurality of wind turbines are commonly used in conjunction with one another to generate electricity and are commonly referred to as a “wind farm.” Wind turbines on a wind farm typically include their own meteorological monitors that perform, for example, temperature, wind speed, wind direction, barometric pressure, and/or air density measurements. In addition, a separate meteorological mast or tower (“met mast”) having higher quality meteorological instruments that can provide more accurate measurements at one point in the farm is commonly provided. The correlation of meteorological data with power output allows the empirical determination of a “power curve” for the individual wind turbines.

Traditionally, wind farms are controlled in a decentralized fashion to generate power such that each turbine is operated to maximize local energy output and to minimize impacts of local fatigue and extreme loads. To this end, each turbine includes a control module, which typically attempts to maximize power output of the turbine in the face of varying wind and grid conditions, while satisfying constraints like sub-system ratings and component loads. Based on the determined maximum power output, the control module controls the operation of various turbine components, such as the generator/power converter, the pitch system, the brakes, and the yaw mechanism to reach the maximum power efficiency.

Amplified wind power demand and customer desire of extracting maximum energy from a wind farm has driven the production of wind turbines having a larger rotor diameter. Such rotor diameters improve energy production of individual wind turbines, but introduce new challenges such as higher fatigue loads. One of the contributing factors to higher fatigue loads is the collective impact of turbine shadow from the increased number of nearby turbines in one or more wind direction(s). Often, these higher fatigue loads exceed nominal/design loads for the turbine model and give few options for developers. More specifically, farm developers must either relocate the turbine(s) or reduce turbine operation in one or more wind direction(s). Thus, since most siting techniques do not account for fatigue load calculations because of the complexity involved and extensive computational requirements, developers end up either with opting suboptimal location(s) with low energy production or loads infeasible location(s) for one or more turbine(s) in the wind farm layout.

Conventional practice is to build the wind farm with a suboptimal layout and opt for post-installation techniques to improve the turbine(s) performance. Such post-installation techniques generally calculate the optimal value(s) of one or more turbine operating parameter(s) based on measured values of one or more site parameter(s). The disadvantages of these available post-installation techniques include but are not limited to: (1) additional investment by the wind farm owner, (2) farm-level operation that requires suboptimal performance by one or more wind turbine(s) in the wind farm to improve the performance of other turbines, (3) trivial annual energy production (AEP) benefits from suboptimal site conditions at one or more turbine location(s), and/or (4) time-consuming implementation and/or validation.

Accordingly, the present disclosure is directed to systems and methods for evaluating loads of a potential wind farm site for multiple wind scenarios that does not require such post-installations techniques.

### BRIEF DESCRIPTION

Aspects and advantages of the invention will be set forth in part in the following description, or may be obvious from the description, or may be learned through practice of the invention.

In one aspect, the present disclosure is directed to a method for evaluating loads of a potential wind farm site for multiple wind scenarios. The method includes (a) receiving, via a computer server, site data of the potential wind farm site representing at least one wind scenario for at least one wind turbine at the potential wind farm site. Further, the method includes (b) selecting, via a user interface, a wind farm configuration based on the at least one wind scenario. The method also includes (c) selecting, via the user interface, a time period for the at least one wind scenario. Thus, the method includes (d) automatically generating, via the computer server, a mechanical loads analysis for the selected wind farm configuration and the time period.

In one embodiment, the method may further include repeating steps (a) through (d) for multiple wind scenarios. Thus, in such embodiments, the method may include selecting a site layout for the potential wind farm site based on the mechanical loads analysis for the multiple wind scenarios.

In another embodiment, the wind farm configuration may include controller settings for a plurality of wind turbines at the potential wind farm site. In further embodiments, the site data may correspond to wind conditions, time of day, seasonal variations, or atmospheric conditions and/or stability. More specifically, in certain embodiments, the wind conditions may include wind direction, wind speed, wind shear, wake, wind gusts, turbine shadow, wind turbulence, wind acceleration, wind veer, or any other suitable wind condition.

In additional embodiments, the time period may correspond to an annual percentage of time for the wind scenario(s). As such, in several embodiments, the method may include scaling the mechanical loads analysis by the annual percentage of time. In particular embodiments, the mechanical loads analysis may correspond to a fatigue mechanical loads analysis.

In further embodiments, the method may include automatically generating the mechanical loads analysis for the selected wind farm configuration and the time period utilizing a rainflow-counting algorithm programmed in a software module of the computer server.

In additional embodiments, the method may include generating the site data via at least one of sensors, the user interface, or a wind mesoscale wind model.

In another aspect, the present disclosure is directed to a system for evaluating loads of a potential wind farm site for multiple wind scenarios. The system includes a user interface having at least one wind farm configuration selection module for selecting a wind farm configuration based on at least one wind scenario for at least one wind turbine at the potential wind farm site and at least one time period selection module for selecting a time period for the at least one wind scenario. Further, the system includes a computer server communicatively coupled to the user interface. The computer server is configured to perform one or more operations, including but not limited to receiving site data of the potential wind farm site representing the at least one wind scenario, receiving a selected wind farm configuration and a selected time period from the user interface, and automatically generating a mechanical loads analysis for the selected wind farm configuration and the selected time period. It should be understood that the system may further include any of the additional features as described herein.

These and other features, aspects and advantages of the present invention will become better understood with reference the following description and appended claims. The accompanying drawings, which are incorporated in and constitute a part of this specification, illustrate the embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a simplified, internal view of one embodiment of a nacelle of a wind turbine according to the present disclosure;

FIG. 3 illustrates a schematic view of one embodiment of a controller of a wind turbine according to the present disclosure;

FIG. 4 illustrates a schematic view of one embodiment of a wind farm according to the present disclosure;

FIG. 5 illustrates a flow chart illustrating a method for evaluating loads of a potential wind farm site for multiple wind scenarios according to the present disclosure;

FIG. 6 illustrates a schematic diagram of one embodiment of a system for evaluating loads of a potential wind farm site for multiple wind scenarios according to the present disclosure; and

FIG. 7 illustrates a flow diagram of one embodiment of a method for evaluating loads of a potential wind farm site for multiple wind scenarios according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present subject matter is directed to a system and method for evaluating loads of a potential wind farm site for multiple wind scenarios. More specifically, the present disclosure is directed to an automated method using a web-based system configured to determine site-specific fatigue loads on a wind turbine using different wind scenarios which are representative of different wind regimes at a potential wind farm site. Thus, the system and method of the present disclosure is configured to generate a site layout that maximizes energy output while staying within a defined mechanical loads constraint. The wind scenarios may be representative of different times of the day, atmospheric stability class, and/or seasonal wind variations. As such, the wind farm analysis, by leveraging multiple wind scenarios, allows engineers to test, recommend, and define different controller software settings for each scenario. Accordingly, operating recommendations can be made that increase annual energy production and minimize fatigue loads, while also increasing wind turbine life for the proposed site.

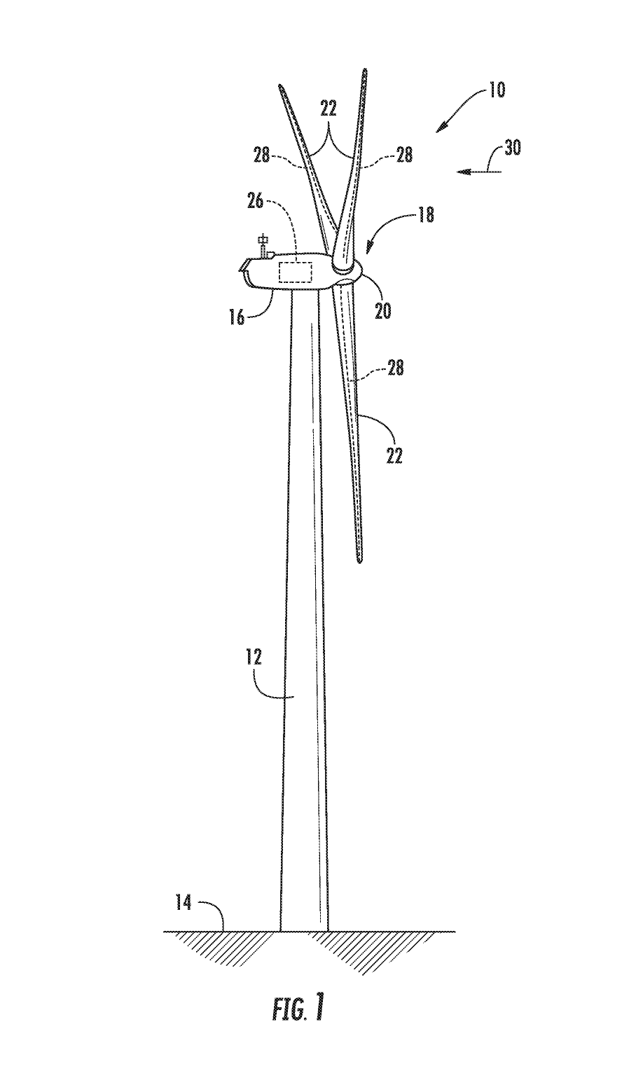

Referring now to the drawings, FIG. 1 illustrates a perspective view of one embodiment of a wind turbine 10 configured to implement the control technology according to the present disclosure. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

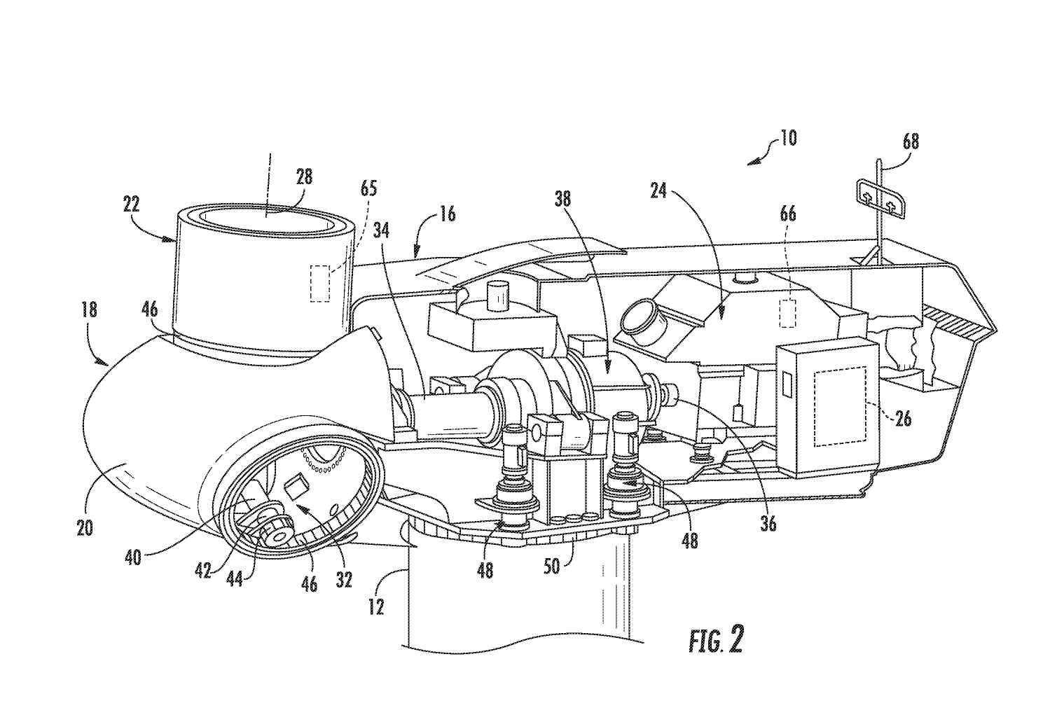

Referring now to FIG. 2, a simplified, internal view of one embodiment of the nacelle 16 of the wind turbine 10 shown in FIG. 1 is illustrated. As shown, the generator 24 may be coupled to the rotor 18 for producing electrical power from the rotational energy generated by the rotor 18. For example, as shown in the illustrated embodiment, the rotor 18 may include a rotor shaft 34 coupled to the hub 20 for rotation therewith. The rotor shaft 34 may, in turn, be rotatably coupled to a generator shaft 36 of the generator 24 through a gearbox 38. As is generally understood, the rotor shaft 34 may provide a low speed, high torque input to the gearbox 38 in response to rotation of the rotor blades 22 and the hub 20. The gearbox 38 may then be configured to convert the low speed, high torque input to a high speed, low torque output to drive the generator shaft 36 and, thus, the generator 24.

Each rotor blade 22 may also include a pitch adjustment mechanism 32 configured to rotate each rotor blade 22 about its pitch axis 28. Further, each pitch adjustment mechanism 32 may include a pitch drive motor 40 (e.g., any suitable electric, hydraulic, or pneumatic motor), a pitch drive gearbox 42, and a pitch drive pinion 44. In such embodiments, the pitch drive motor 40 may be coupled to the pitch drive gearbox 42 so that the pitch drive motor 40 imparts mechanical force to the pitch drive gearbox 42. Similarly, the pitch drive gearbox 42 may be coupled to the pitch drive pinion 44 for rotation therewith. The pitch drive pinion 44 may, in turn, be in rotational engagement with a pitch bearing 46 coupled between the hub 20 and a corresponding rotor blade 22 such that rotation of the pitch drive pinion 44 causes rotation of the pitch bearing 46. Thus, in such embodiments, rotation of the pitch drive motor 40 drives the pitch drive gearbox 42 and the pitch drive pinion 44, thereby rotating the pitch bearing 46 and the rotor blade 22 about the pitch axis 28. Similarly, the wind turbine 10 may include one or more yaw drive mechanisms 48 communicatively coupled to a turbine controller 26, with each yaw drive mechanism(s) 48 being configured to change the angle of the nacelle 16 relative to the wind (e.g., by engaging a yaw bearing 50 of the wind turbine 10).

Still referring to FIG. 2, the wind turbine 10 may also include one or more sensors 65, 66, 68 for measuring operating and/or wind conditions of the wind turbine 10. For example, the sensors may include blade sensors 65 for measuring a pitch angle of one of the rotor blades 22 or for measuring a loading acting on one of the rotor blades 22; generator sensors 66 for monitoring the generator (e.g. torque, rotational speed, acceleration and/or the power output); and/or various wind sensors 68 for measuring various wind parameters (e.g. wind speed, wind direction, etc.). Further, the sensors 65, 66, 68 may be located near the ground of the wind turbine 10, on the nacelle 16, on a meteorological mast of the wind turbine 10, or any other location in the wind farm.

It should also be understood that any other number or type of sensors may be employed and at any location. For example, the sensors may be accelerometers, pressure sensors, strain gauges, angle of attack sensors, vibration sensors, MIMU sensors, camera systems, fiber optic systems, anemometers, wind vanes, Sonic Detection and Ranging (SODAR) sensors, infra lasers, Light Detecting and Ranging (LIDAR) sensors, radiometers, pitot tubes, rawinsondes, other optical sensors, and/or any other suitable sensors. It should be appreciated that, as used herein, the term “monitor” and variations thereof indicates that the various sensors of the wind turbine 10 may be configured to provide a direct measurement of the parameters being monitored or an indirect measurement of such parameters. Thus, the sensors 65, 66, 68 may, for example, be used to generate signals relating to the parameter being monitored, which can then be utilized by the controller 26 to determine the actual condition.

Referring back to FIG. 1, the wind turbine controller 26 may be centralized within the nacelle 16. However, in other embodiments, the controller 26 may be located within any other component of the wind turbine 10 or at a location outside the wind turbine. Further, the controller 26 may be communicatively coupled to any number of the components of the wind turbine 10 in order to control the operation of such components and/or to implement a control action. As such, the controller 26 may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals.

Accordingly, the controller 26 may generally be configured to control the various operating modes of the wind turbine 10 (e.g., start-up or shut-down sequences), de-rate or up-rate the wind turbine 10, and/or control various components of the wind turbine 10. For example, the controller 26 may be configured to control the blade pitch or pitch angle of each of the rotor blades 22 (i.e., an angle that determines a perspective of the rotor blades 22 with respect to the direction of the wind) to control the power output generated by the wind turbine 10 by adjusting an angular position of at least one rotor blade 22 relative to the wind. For instance, the controller 26 may control the pitch angle of the rotor blades 22 by rotating the rotor blades 22 about a pitch axis 28, either individually or simultaneously, by transmitting suitable control signals to a pitch drive or pitch adjustment mechanism (not shown) of the wind turbine 10.

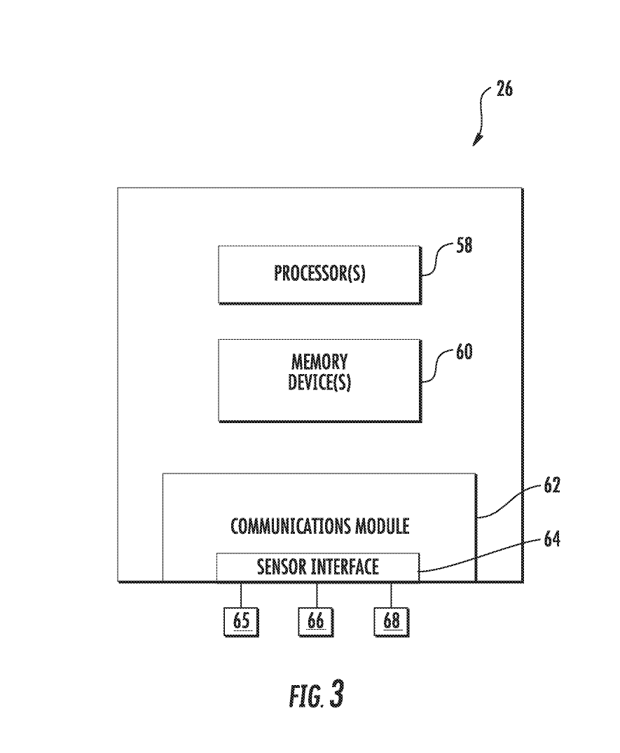

In addition, according to one aspect of the present disclosure, the controller 26 may be programmed with various settings that are determined pre-installation of the wind turbine site. Referring particularly to FIG. 3, a block diagram of one embodiment of suitable components that may be included within the controller 26 is illustrated in accordance with aspects of the present disclosure. As shown, the controller 26 may include one or more processor(s) 58 and associated memory device(s) 60 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, application-specific processors, digital signal processors (DSPs), Application Specific Integrated Circuits (ASICs), Field Programmable Gate Arrays (FPGAs), and/or any other programmable circuits. Further, the memory device(s) 60 may generally include memory element(s) including, but are not limited to, computer readable medium (e.g., random access memory (RAM)), computer readable non-volatile medium (e.g., a flash memory), one or more hard disk drives, a floppy disk, a compact disc-read only memory (CD-ROM), compact disk-read/write (CD-R/W) drives, a magneto-optical disk (MOD), a digital versatile disc (DVD), flash drives, optical drives, solid-state storage devices, and/or other suitable memory elements.

Additionally, the controller 26 may also include a communications module 62 to facilitate communications between the controller 26 and the various components of the wind turbine 10. For instance, the communications module 62 may include a sensor interface 64 (e.g., one or more analog-to-digital converters) to permit the signals transmitted by one or more sensors 65, 66, 68 to be converted into signals that can be understood and processed by the controller 26. Furthermore, it should be appreciated that the sensors 65, 66, 68 may be communicatively coupled to the communications module 62 using any suitable means. For example, as shown in FIG. 3, the sensors 65, 66, 68 are coupled to the sensor interface 64 via a wired connection. However, in alternative embodiments, the sensors 65, 66, 68 may be coupled to the sensor interface 64 via a wireless connection, such as by using any suitable wireless communications protocol known in the art. For example, the communications module 62 may include the Internet, a local area network (LAN), wireless local area networks (WLAN), wide area networks (WAN) such as Worldwide Interoperability for Microwave Access (WiMax) networks, satellite networks, cellular networks, sensor networks, ad hoc networks, and/or short-range networks. As such, the processor 58 may be configured to receive one or more signals from the sensors 65, 66, 68.

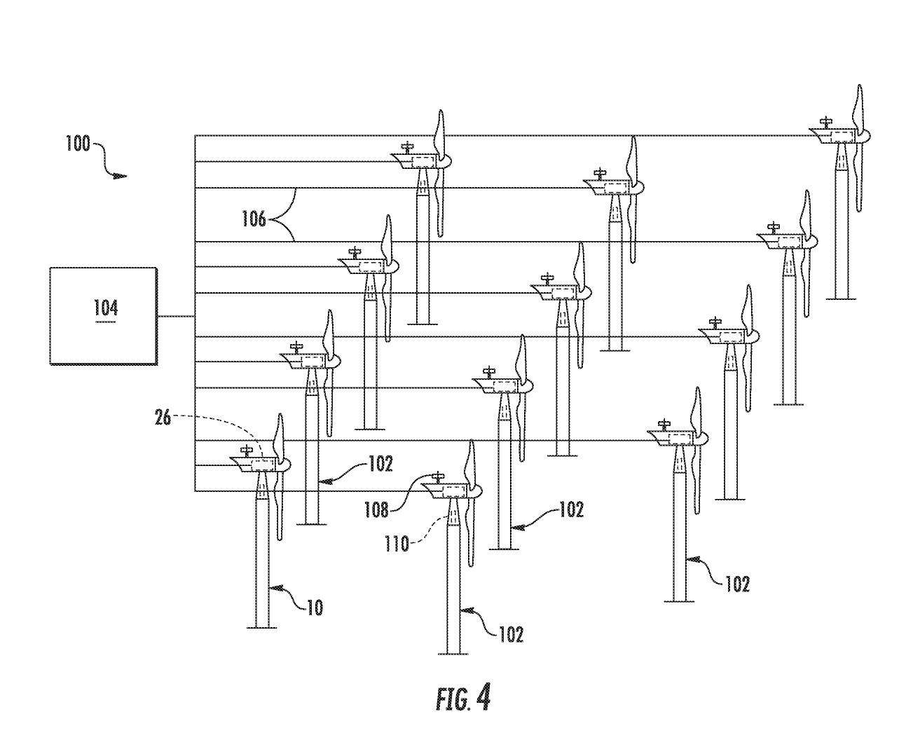

Referring now to FIG. 4, a wind farm 100 that is controlled according to the system and method of the present disclosure is illustrated. As shown, the wind farm 100 may include a plurality of wind turbines 102, including the wind turbine 10 described above, and a farm controller 104. For example, as shown in the illustrated embodiment, the wind farm 100 includes twelve wind turbines, including wind turbine 10. However, in other embodiments, the wind farm 100 may include any other number of wind turbines, such as less than twelve wind turbines or greater than twelve wind turbines. In one embodiment, the controller 26 of the wind turbine 10 may be communicatively coupled to the farm controller 104 through a wired connection, such as by connecting the controller 26 through suitable communicative links 106 or networks (e.g., a suitable cable). Alternatively, the controller 26 may be communicatively coupled to the farm controller 104 through a wireless connection, such as by using any suitable wireless communications protocol known in the art. In addition, the farm controller 104 may be generally configured similar to the controllers 26 for each of the individual wind turbines 102 within the wind farm 100.

In several embodiments, one or more of the wind turbines 102 in the wind farm 100 may include a plurality of sensors 108, 110 for monitoring various operational data of the individual wind turbines 102 and/or one or more wind parameters of the wind farm 100. For example, as shown, each of the wind turbines 102 includes a wind sensor 108, such as an anemometer or any other suitable device, configured for measuring wind speeds or any other wind parameter. For example, in one embodiment, the wind parameters include information regarding at least one of or a combination of the following: a wind gust, a wind speed, a wind direction, a wind acceleration, a wind turbulence, a wind shear, a wind veer, a wake, SCADA information, or similar. Further, each of the wind turbines 102 also includes a sensor 110 for monitoring additional operational parameters of the wind turbine 102.

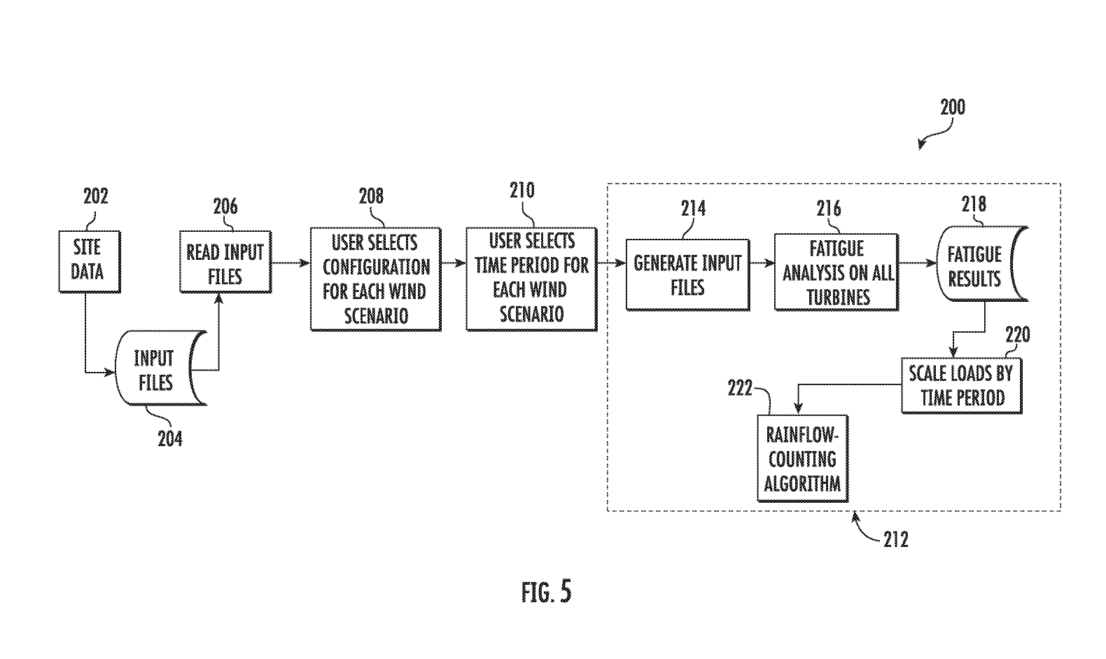

Referring now to FIG. 5, a flow chart illustrating a method 200 for evaluating loads of a potential wind farm site, such as the wind farm 100 of FIG. 4, for multiple wind scenarios is illustrated. As shown at 202, the method 200 includes receiving, via a computer server 251, site data from the potential wind farm site representing at least one wind scenario for at least one wind turbine 102 at the potential wind farm site. As used herein, the computer server 251 generally refers to a remote computer server 251 separate from the turbine controller 26. As such, the mechanical loads analysis described herein can be completed before the wind farm is installed. Further, the computer server 251 may operate similar to the controller 26 illustrate in FIG. 3. It should also be understood, however, that the turbine controller 26 may also be configured to perform the mechanical loads analysis described herein. In certain embodiments, the site data may correspond to wind conditions, time of day, seasonal variations, or atmospheric conditions and/or stability. More specifically, in certain embodiments, the wind conditions may include wind direction, wind speed, wind shear, wake, wind gusts, turbine shadow, wind turbulence, wind acceleration, wind veer, or any other suitable wind condition. As shown at 204, the computer server 251 converts the site data 202 to input files that can be read by the processor(s) thereof. As shown at 106, the computer server 251 reads the input files 204.

As shown at 208 and 210, a user selects a wind farm configuration for each wind scenario and a time period for each of the wind scenarios via a user interface communicatively coupled to the computer server 251. In certain embodiments, the wind farm configuration(s) as described herein may include controller settings for a plurality of wind turbines 102 at the potential wind farm site 100. In addition, the time period(s) as described herein may correspond to day or night periods, periods for each season, periods for when the atmosphere is stable versus unstable, an annual percentage of time for the wind scenario(s), and/or the percentage of a certain controller setting in the overall simulation (e.g. 1 year, 10 years, 20 years, etc.). Therefore, the meteorological data could represent any of the above situations and/or multiple scenarios. For example, a user may select a site having two wind scenarios of day and night, which on an annual basis would include 50% of the time each.

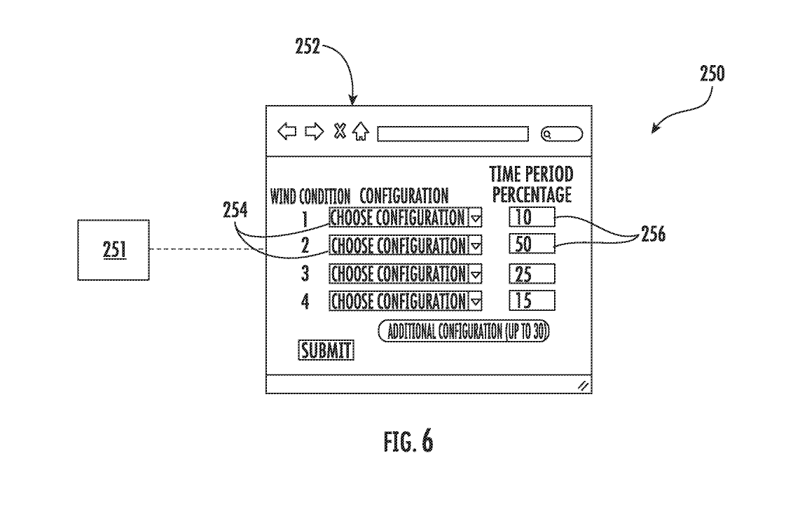

For example, as shown in FIG. 6, a schematic diagram of one embodiment of a system 250 for evaluating loads of a potential wind farm site, such as the wind farm 100 of FIG. 4, for multiple wind scenarios is illustrated. More specifically, as shown, the system 250 includes a computer server 251 and a user interface 252 having a plurality of wind farm configuration selection modules 254 for selecting a wind farm configuration based on at least one wind scenario for at least one wind turbine 102 at the potential wind farm site. In addition, as shown, the user interface 252 also includes a plurality of time period selection modules 256 for selecting a time period for the wind scenario(s). It should be understood that the user interface 252 may include any suitable number of wind farm configuration selection modules 254 as well as time period selection modules 256. In addition, the wind farm configuration selection modules 254 and/or the time period selection modules 256 may have any suitable format. For example, as shown, the wind farm configuration selection modules 254 are configured as drop-down menus, whereas, the time period selection modules 256 are configured as fill-in boxes.

Referring back to FIG. 5, as shown within box 212 and after the user makes the required selections, the computer server 251 performs a plurality of processing steps to generate a mechanical loads analysis for the selected wind farm configuration(s) and the selected time period(s). More specifically, as shown at 214, the computer server 251 may generate input files that can be read by simulation software programmed therein. As shown at 216, the controller 26 runs the simulation software to generate the mechanical loads analysis (e.g. a fatigue analysis) on the wind turbine(s) 102. As shown at 218, the computer server 251 generates the results. As shown at 220, the computer server 251 may optionally scale the results based on the time period (e.g. the annual percentage). In addition, as shown at 222, the computer server 251 may also run the mechanical loads analysis through a rainflow-counting algorithm that is programmed in a software module of the computer server 251. As used herein, a rainflow counting algorithm generally refers to an algorithm that can be used in to the analysis of fatigue data to reduce a spectrum of varying stress into a set of simple stress reversals.

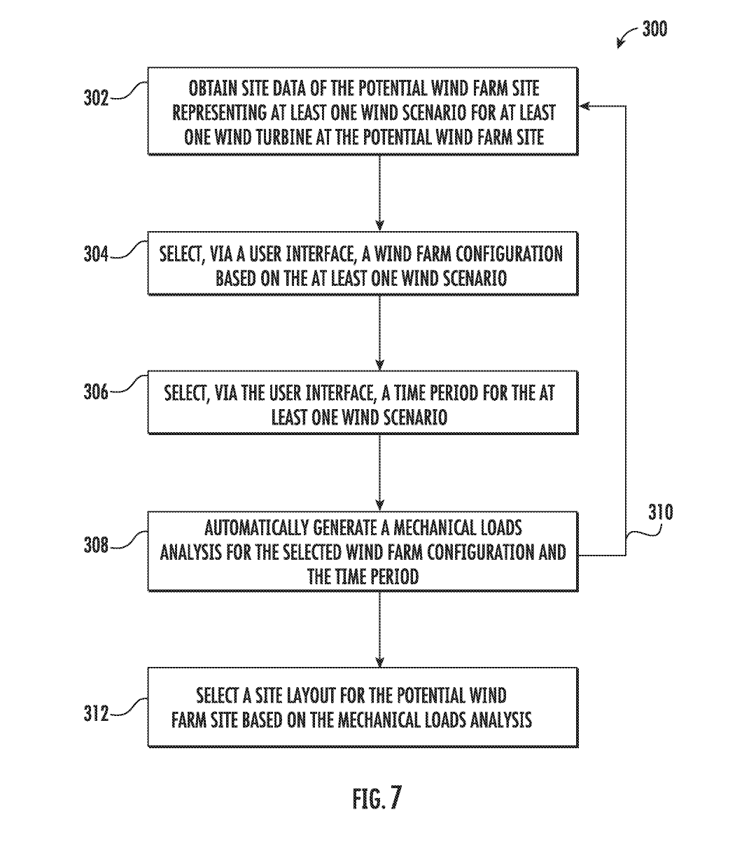

Referring now to FIG. 7, a flow diagram of another embodiment of a method 300 for evaluating loads of a potential wind farm site, such as the wind farm 100 of FIG. 4, for multiple wind scenarios is illustrated. As shown at 302, the method 300 includes receiving, via the computer server 251, site data of the potential wind farm site representing at least one wind scenario for at least one wind turbine at the potential wind farm site. As shown at 304, the method 300 includes selecting, via the user interface 252, a wind farm configuration based on the at least one wind scenario. As shown at 306, the method 300 includes selecting, via the user interface 252, a time period for the at least one wind scenario. As shown at 308, the method 300 includes automatically generating, via the computer server 251, a mechanical loads analysis for the selected wind farm configuration and the time period. As shown by arrow 310, in one embodiment, the method 300 may further include repeating steps 302 through 308 for multiple wind scenarios. Thus, as shown at 312, the method 300 may include selecting a site layout for the potential wind farm site based on the mechanical loads analysis for the multiple wind scenarios.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for evaluating loads of a potential wind farm site for multiple wind scenarios, the method comprising:
(a) receiving, via a computer server, site data of the potential wind farm site representing at least one wind scenario for at least one wind turbine at the potential wind farm site;
(b) selecting, via a user interface, a wind farm configuration based on the at least one wind scenario;
(c) selecting, via the user interface, a time period for the at least one wind scenario; and,
(d) automatically generating, via the computer server, a mechanical loads analysis for the selected wind farm configuration and the time period.

2. The method of claim 1, further comprising repeating steps (a) through (d) for multiple wind scenarios.

3. The method of claim 2, further comprising selecting a site layout for the potential wind farm site based on the mechanical loads analysis for the multiple wind scenarios.

4. The method of claim 1, wherein the wind farm configuration comprises controller settings for a plurality of wind turbines at the potential wind farm site.

5. The method of claim 1, wherein the site data comprises at least one of wind conditions, time of day, seasonal variations, or atmospheric stability.

6. The method of claim 5, wherein the wind conditions comprise at least one of wind direction, wind speed, wind shear, wake, wind gusts, turbine shadow, wind turbulence, wind acceleration, or wind veer.

7. The method of claim 1, wherein the time period comprises an annual percentage of time for the at least one wind scenario.

8. The method of claim 7, further comprising scaling the mechanical loads analysis by the annual percentage of time.

9. The method of claim 1, wherein the mechanical loads analysis comprises a fatigue mechanical loads analysis.

10. The method of claim 1, further comprising automatically generating the mechanical loads analysis for the selected wind farm configuration and the time period utilizing a rainflow-counting algorithm programmed in a software module of the computer server.

11. The method of claim 1, further comprising generating the site data via at least one of sensors, the user interface, or a wind mesoscale wind model.

12. A system for evaluating loads of a potential wind farm site for multiple wind scenarios, the system comprising:
a user interface comprising:
at least one wind farm configuration selection module for selecting a wind farm configuration based on at least one wind scenario for at least one wind turbine at the potential wind farm site; and,
at least one time period selection module for selecting a time period for the at least one wind scenario; and,
a computer server communicatively coupled to the user interface, the computer server configured to perform one or more operations, the one or more operations comprising:
receiving site data of the potential wind farm site representing the at least one wind scenario;
receiving a selected wind farm configuration and a selected time period from the user interface; and,
automatically generating a mechanical loads analysis for the selected wind farm configuration and the selected time period.

13. The system of claim 12, wherein the user interface comprises a plurality of wind farm configuration selection modules and a plurality of time period selection modules, the one or more operations further comprising:
receiving site data of the potential wind farm site representing the multiple wind scenarios;
receiving a plurality of selected wind farm configurations and a plurality of selected time periods from the user interface; and, automatically generating a mechanical loads analysis for the selected wind farm configurations and the selected time periods.

14. The system of claim 13, wherein the one or more operations further comprise selecting a site layout for the potential wind farm site based on the mechanical loads analysis for the multiple wind scenarios.

15. The system of claim 12, wherein the wind farm configuration comprises controller settings for a plurality of wind turbines at the potential wind farm site.

16. The system of claim 12, wherein the site data comprises at least one of wind conditions, time of day, seasonal variations, or atmospheric stability.

17. The system of claim 16, wherein the wind conditions comprise at least one of wind direction, wind speed, wind shear, wake, wind gusts, turbine shadow, wind turbulence, wind acceleration, or wind veer.

18. The system of claim 12, wherein the time period comprises an annual percentage of time for the at least one wind scenario.

19. The system of claim 18, further comprising scaling the mechanical loads analysis by the annual percentage of time.

20. The system of claim 12, further comprising automatically generating the mechanical loads analysis for the selected wind farm configuration and the time period utilizing a rainflow-counting algorithm programmed in a software module of the computer server.
